(19) United States
(12) Patent Application Publication
(10) Pub. No.: US 2026/0145456 A1
(43) Pub. Date: May 28, 2026

(54) TRANSFER IMAGING SYSTEM

(71) Applicant: Sawgrass Technologies, Inc., Mt. Pleasant, SC (US)

(72) Inventors: Ming Xu, Malvern, PA (US); Dimple Patel, Mt. Pleasant, SC (US); Alexander Tokarev, Mt. Pleasant, SC (US)

(73) Assignee: Sawgrass Technologies, Inc., Mt. Pleasant, SC (US)

(21) Appl. No.: 19/456,489

(22) Filed: Jan. 22, 2026

Related U.S. Application Data
(63) Continuation-in-part of application No. 19/057,207, filed on Feb. 19, 2025.
(60) Provisional application No. 63/638,531, filed on Apr. 25, 2024.
(60) Provisional application No. 63/669,951, filed on Jul. 11, 2024.

(51) Int. Cl. B41M 5/52; B41J 2/005; B41J 2/01; B41J 2/21; B41M 5/50

(52) U.S. Cl. CPC B41M 5/52; B41J 2/0057; B41J 2/2117; B41M 5/506; B41J 2002/012; B41M 2205/38; B41M 2205/40

(57) ABSTRACT

A system for imaging a substrate has a first substrate, designated as Medium A. Medium A is digitally imaged, such as by printing a color image formed with CMYK inks. Medium A also has a glue ink layer formed over the image layer, and may have a white ink layer positioned between the image layer, and the glue ink layer. Another substrate, designated as Medium B, has a non-substantial film forming polymeric coating formulated for lamination of the polymeric coating on Medium A. Medium B is laminated under pressure onto Medium A to form the polymeric coating on the imaged portions of Medium A. The image is then transferred under heat and pressure from Medium A to a final substrate upon which the image is to appear. The image layer is formed over the white ink layer as it appears on the final substrate.

This application is a Continuation in Part of Ser. No. 19/057,207 filed Feb. 19, 2025 which claimed priority from Provisional Application Ser. No. 63/638,531, filed Apr. 5, 2024 and Provisional Application Ser. No. 63/669,951, filed Jul. 11, 2024, and upon which priority from both is claimed hereby.

### BACKGROUND OF THE INVENTION

Digital transfer printing technologies have been widely adopted for producing customized images on textiles and other substrates. Among these, powder-based direct-to-film (DTF) processes have gained popularity due to their ability to deposit white and color images onto dark fabrics. However, such powder-based systems present multiple environmental, technical and operational limitations.

Powdered DTF processes rely on the mechanical application of fine thermoplastic powders onto wet ink layers, often using tumbling, shaking, or vibration. These steps introduce inconsistencies in powder distribution, leading to uneven adhesion, loss of fine detail, edge roughness, and variable hand-feel. Moreover, fine polymer powders present handling challenges, including airborne particulate hazards, dust accumulation, and increased fire and explosion risk in production environments. These issues are amplified for small-footprint or office-scale digital printing systems.

Additionally, powder-based approaches are inherently limited in producing high-resolution images, micro-features, and smooth gradients, as powder granularity and mechanical deposition variability constrain achievable detail. Accordingly, there remains a need for powder-free digital transfer systems capable of producing high-quality, fine-detail images with consistent polymer loading, improved safety, and simplified equipment requirements.

### SUMMARY OF THE INVENTION

The present disclosure is a digital image transfer printing system employing multi-layer digital inkjet deposition, glue ink interfaces, and selective lamination transfer of thermoplastic or polymeric materials for subsequent heat and pressure transfer to final substrates. The invention may be used to image textile, fabric, and apparel decoration, including dark-colored substrates, while avoiding particulate powders and film-like transfer layers.

In one embodiment, the invention is a digital transfer imaging system comprising a glue ink to provide selective transfer of thermoplastic or polymeric materials. The system may employ a single printhead printer, or a three-tier digital inkjet printer for printing on a first transfer medium, followed by pressure-assisted lamination with a second transfer medium carrying a polymer coating, with subsequent heat transfer to a final substrate.

In one aspect, a digital inkjet printer deposits, in sequence:
1. A color ink layer;
2. A white pigmented ink layer, configured to provide opacity and coverage over dark substrates; and
3. A substantially colorless glue ink layer (or lightly pigmented glue ink layer), configured to provide tackiness, adhesion, and selective affinity for polymer pickup.

Following digital imaging, a second transfer medium carrying a discretely coated thermoplastic or polymeric material, with or without colorant, is brought into intimate contact with the printed surface of the first transfer medium. Mechanical pressure, with or without applied heat, causes the polymeric coating on the second transfer medium to selectively transfer only onto regions of the first transfer medium where the glue ink is present. The second transfer medium is then removed and discarded, leaving the first transfer medium bearing the digitally printed image layers and a transferred, relatively dry polymeric material confined to the imaged regions.

The resulting composite image is subsequently transferred to a final substrate using conventional heat-and-pressure transfer equipment, such as a manual or pneumatic heat press, thereby forming a durable image without the use of loose powders or continuous polymer films. The present invention integrates digitally controlled inkjet printing with a specialized digital transfer medium that limits transfer from transfer medium to the imaged portion of transfer medium. By providing jetted materials that enhance adhesion of the image to the final substrate. This approach minimizes excess material transfer, ensuring vibrant, high-resolution images with a soft hand and feel. The application of jetted materials to selected portions of the image are controlled and optimized, such as by software.

### BRIEF DESCRIPTION OF FIGURES

FIG. 1 illustrates an example of a digital image for digital printing and subsequent transfer of the printed image to a final substate.

FIG. 2 is an illustration showing an example of hardware for transfer imaging.

FIG. 3 shows layers of a transfer medium according to the invention.

FIG. 4 depicts a portion of a final substrate that is imaged using the system of the invention, wherein the final substrate has little to no affinity for sublimation dyes.

FIG. 5 is a flow chart showing steps of an embodiment using both ink jet and electrographic printing for transfer imaging of a final substrate.

FIG. 6A is a schematic diagram illustrating an overall process flow for producing a transferred image according to one embodiment of the present invention, including digital printing of multiple ink layers on a first transfer medium, lamination with a second transfer medium, separation of the second transfer medium, and final heat-and-pressure transfer to a substrate.

FIG. 6B is a schematic diagram illustrating an overall process flow for producing a transferred image according to another embodiment of the present invention, including digital printing of multiple ink layers on a first transfer medium (Medium A) and a second transfer medium (Medium B), lamination with the second transfer medium, separation of the second transfer medium, and final heat-and-pressure transfer to a substrate.

FIG. 7 is a schematic cross-sectional view of a first transfer medium (Medium A) bearing sequentially printed CMYK color ink, white ink, and glue ink layers which may be formed using an electric piezo inkjet printing system.

FIG. 8 is a schematic cross-sectional view of a second transfer medium (Medium B) comprising a carrier substrate and a discretely applied, non-substantial film-forming polymeric coating.

FIG. 9 is a schematic view illustrating a lamination step in which the second transfer medium is brought into contact with glue-ink-printed regions of the first transfer medium, resulting in selective transfer of polymeric material to the imaged regions.

FIG. 10 is a schematic view illustrating separation of the second transfer medium following lamination, wherein the second transfer medium is removed and discarded while the first transfer medium retains polymeric material localized to the imaged regions.

FIG. 11 is a schematic comparative illustration showing fine-feature image reproduction achievable using selective polymer transfer according to the present disclosure.

### DETAILED DESCRIPTION OF EMBODIMENTS

### Three-Tier Digital Printing Architecture

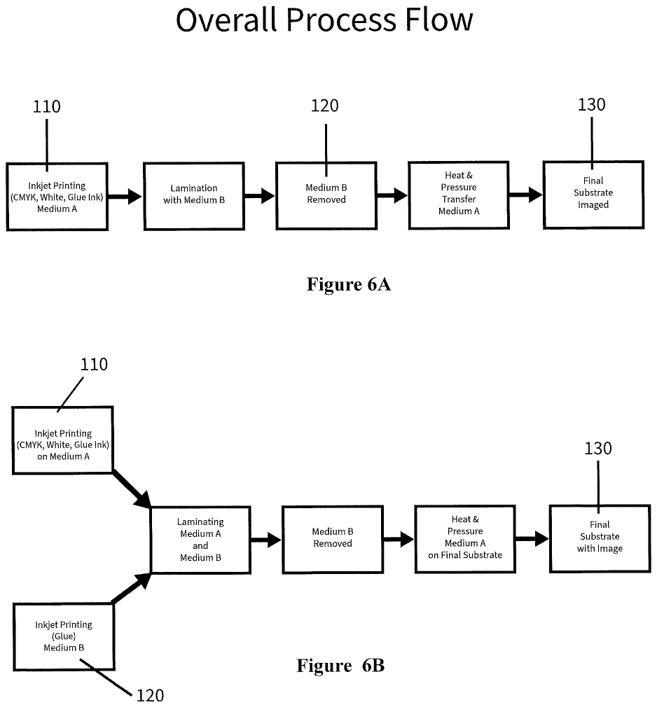

The overall flow of the three-tier digital printing process is shown in FIG. 6A. The process involves three substrates, with the process ending with image transferred to a final substrate 130. FIG. 6B shows another embodiment, wherein Medium B is printed with glue ink before lamination with Medium B.

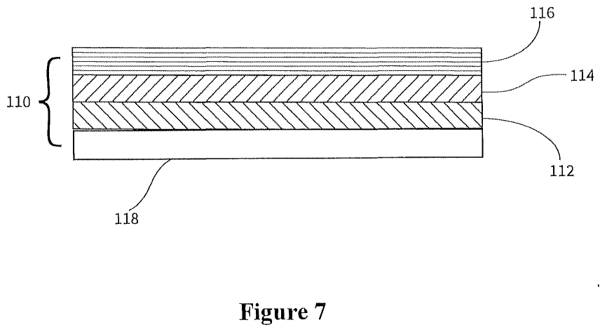

In one embodiment, a digital inkjet printing system employing electric piezo printheads is configured to deposit three distinct ink layers in a controlled sequence: (i) CMYK color inks 112, (ii) white pigmented inks 114, and (iii) substantially colorless glue inks 116 digitally applied to a substrate 118 to form the first transfer medium (Medium A) 110. FIG. 7. The inks may be printed sequentially using a single digital printer equipped with multiple printheads, or by multiple printers arranged in series, provided that sufficient registration accuracy is maintained to preserve image fidelity and layer-to-layer overlay. In certain embodiments, the printer and/or transport may include fiducial recognition, encoder feedback, or other registration mechanisms suitable to align the CMYK, white, and glue ink layers.

The color image layer is formed by inkjet printing one or more color inks and defines the color image content. A white ink layer 114 may be selectively deposited between the color image layer 112 and a glue ink layer 116. When present, the white ink layer 114 functions to provide optical hiding and to mask dark or porous final substrates from the color image upon subsequent transfer to the final substrate. The glue ink layer 116 is deposited over the color image layer 112 and, where present, the white ink layer 114, and functions as an active interfacial layer that governs subsequent selective lamination transfer of polymeric material from a second transfer medium and contributes to final adhesion and bonding performance on the final substrate.

The glue ink may comprise one or more resinous or polymeric materials selected to be jettable through electric piezo inkjet printheads and to exhibit controlled tack, wetting behavior, and thermal response. Suitable glue ink compositions include, without limitation, thermoplastic polyurethanes, polyester-polyurethanes, acrylics, polyesters, copolymers thereof, or combinations thereof. The glue ink may include additives to adjust viscosity, surface tension, and/or glass transition or softening behavior.

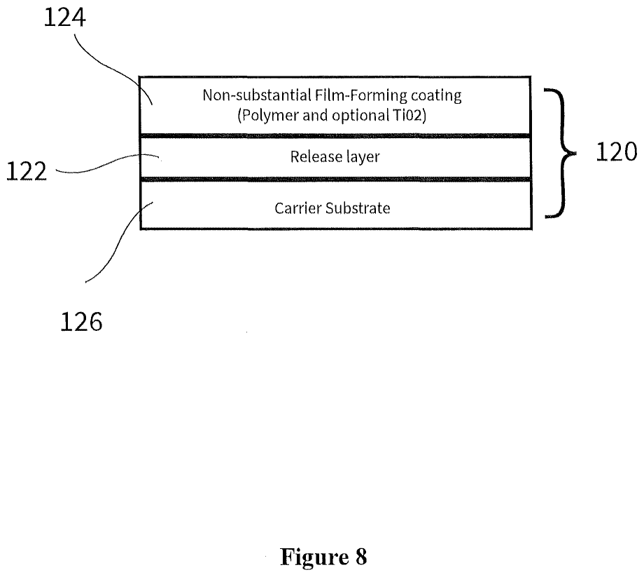

In operation, the glue ink is formulated so that interfacial affinity between the glue ink and the discrete polymeric coating 124 on Medium B 120 is greater than the affinity between that polymeric coating 124 and the carrier substrate 126 of Medium B. FIG. 8. An optional release layer 122 may be used to facilitate transfer of the polymeric coating. Without being bound to theory, selective pickup may be described as an interfacial energy inversion where the polymeric material preferentially wets and adheres to the glue-ink-covered regions rather than remaining on Medium B. In certain embodiments, this selectivity is promoted by controlling surface energy and wetting behavior, recognizing that adhesion strength depends on molecular attraction and surface energy relationships.

In certain embodiments, the glue ink is not a pressure-sensitive adhesive (PSA) transfer layer that is “permanently tacky” at use conditions; rather, the glue ink may be formulated to be tacky when wet and/or to become tacky upon controlled thermal activation during lamination and/or final transfer. This distinction is useful because PSAs are commonly characterized as permanently tacky and not requiring activation by heat or solvent, whereas the disclosed glue ink may be engineered for process-timed tack and selective pickup behavior.

In certain embodiments, the glue ink is substantially colorless. In other embodiments, the glue ink includes a low loading of white or light pigment to supplement opacity without materially affecting color integrity, hue, or image sharpness.

A second transfer medium (Medium B) is provided, comprising a carrier substrate supporting a discretely applied, non-substantial film-forming polymeric or resinous coating. FIG. 8. The carrier substrate 126 may comprise paper, polymeric film (e.g., polyester film), coated paper, or other web/sheet materials used in coating or lamination. In some embodiments the carrier substrate may be treated (e.g., corona, primer, or other surface treatment) or untreated.

The disclosed system is not dependent on “silicone release liner” constructions that are commonly used to protect and release PSA layers in transfer adhesive products; rather, selective transfer behavior is primarily governed by the glue-ink-mediated interfacial affinity, thermal melt property, and process conditions. Release liners are commonly described as silicone-coated backings intended to provide controlled release of PSAs and protect adhesive layers during handling.

As used herein, the term “non-substantial film-forming” refers to a polymeric or resinous coating that is present in a discontinuous, non-self-supporting, and non-load-bearing form that does not constitute a continuous adhesive film, laminate, or release layer on the carrier substrate. The polymeric material is applied at a coating weight, thickness, and spatial distribution intentionally insufficient to form a freestanding film, to support cohesive peeling, or to define global adhesion across the carrier substrate. Instead, the polymeric material remains discretely distributed and is selectively transferred only in regions where a digitally printed glue ink layer establishes localized interfacial affinity and thermal activation.

The polymeric material may be substantially colorless or may include one or more colorants, for example titanium dioxide (TiO₂), without altering its non-substantial film-forming character. In such embodiments, the presence or absence of colorant does not cause the polymeric material to function as a continuous background film; rather, selectively transferred polymeric material forms a localized background layer only in image-corresponding regions. In this manner, precise ink-defined weeding, sharp image boundaries, and controlled background coverage are achieved through glue-ink-mediated selectivity rather than through pre-formed continuous adhesive layers or silicone release constructions.

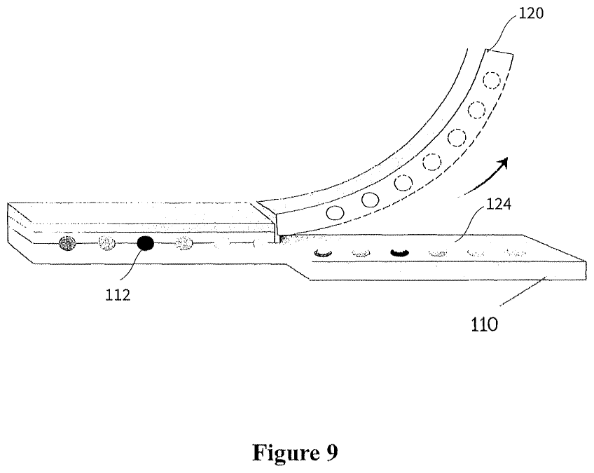

The polymeric coating 124 of Medium B 120 may include thermoplastic or thermoset-capable materials selected to exhibit strong affinity, adhesion, and/or bonding capability with the final transfer substrate 130. FIG. 8; FIG. 9. Suitable materials include, without limitation, polyurethanes, polyester-polyurethanes, polyamides, thermoplastic polyesters, copolyesters, acrylic-modified polyurethanes, thermoplastic elastomers, or combinations thereof. In certain embodiments, the polymeric material is selected to interact favorably with sublimation colorants and/or polymeric binders present in the digitally printed ink layers, thereby improving wash fastness, abrasion resistance, and image integrity upon final heat transfer. The polymer composition 124 may optionally include crosslinkable ingredients (including blocked isocyanates, latent curing agents, or reactive functional groups) configured to activate primarily during the final heat-and-pressure transfer step. Multiple-pass coating techniques may also be used to ensure coating thickness and potential multiple-layer coating structure.

The polymeric coating 124 is applied and dried under conditions that avoid formation of a substantial continuous film prior to lamination. While limited local coalescence may occur, the coating does not form a self-supporting, peelable, or continuous film layer across Medium B. In various embodiments, the effective particle size or agglomerate size of the coating material, after drying, is substantially less than 100 microns, and is selected so the coating remains discontinuous or semi-discrete while still being transferable in the presence of glue ink. In one embodiment, glue in is deposited on Medium B. FIG. 6B.

Explicit contrast to hot-melt adhesive films (to defeat “TPU film lamination” prior art). In certain embodiments, Medium B is expressly distinguished from hot-melt adhesive films (e.g., continuous thermoplastic polyurethane films) used in conventional lamination, which are supplied as self-supporting films having defined thickness (for example, on the order of tens to hundreds of microns) and that soften/melt over a characteristic temperature range. By way of example, TPU hot-melt adhesive films are commercially described in thickness ranges roughly from about 0.0125 mm to 0.15 mm and melting ranges around 70-95° C. In contrast, the polymeric coating on Medium B of the present disclosure is deposited in a non-substantial film-forming manner and is not intended to be handled, transferred, or laminated as a continuous film sheet.

In certain embodiments, Medium B 120 is selected such that the polymeric coating 124 exhibits lower effective adhesion to the carrier substrate than to the glue-ink-covered regions 116 of Medium A 110 under lamination conditions. This may be implemented by selecting carrier substrate surface energy/polarity and coating chemistry to promote preferential wetting/adhesion to the glue ink. Surface energy is recognized as a factor that affects adhesion strength; accordingly, the carrier substrate may be chosen or treated to support predictable selective pickup while avoiding reliance on silicone release coatings used in PSA liner technology.

The polymeric coating 124 on Medium B 120 may be deposited using coating techniques including, without limitation, screen printing, Meyer-rod coating, pad printing, offset printing, gravure coating, slot-die, or other controlled deposition processes capable of producing discrete or semi-discrete polymer distributions. Water-based coating systems are preferred in certain embodiments to enable low-temperature drying and to inhibit premature coalescence. Drying conditions are selected to remove carrier liquids while preserving the non-substantial film-forming morphology of the coating.

The dry coating weight on Medium B 120 may generally range from approximately 30 g/m² to 200 g/m², with selection guided by (i) sufficient polymer pickup and transfer durability and (ii) minimization of stiffness or hand-feel in the final transferred image, particularly for textile and apparel applications.

After digital printing on Medium A 110, Medium B 120 is laminated or pressed against the printed surface such that the polymeric coating 124 of Medium B contacts the glue ink layer 116 of Medium A. FIG. 9. Mechanical pressure is applied to ensure contact of Medium B with imaged regions of Medium A. Lamination may be performed with or without applied heat, depending on the embodiment and the glue ink thermal response.

In one embodiment, lamination occurs while the glue ink 116 remains partially wet or tacky. The affinity between the glue ink and the polymeric coating 124, combined with pressure-driven intimate contact, causes the polymeric material to transfer selectively from Medium B 120 to the first transfer medium only in regions where glue ink is present. FIG. 9.

In another embodiment, lamination occurs after the glue ink 116 has dried. In this embodiment, heat is applied during lamination to soften or partially liquefy the glue ink without substantially softening the polymeric coating 124 on Medium B. The softened glue ink then captures the polymeric material through localized wetting and interfacial affinity, enabling transfer without the need for a continuous donor film.

In certain embodiments, the selective nature of the lamination transfer is confirmed by the absence of substantial polymer transfer when glue ink is not present. For example, when Medium B 120 is laminated against portions of Medium A 110 the first transfer medium lacking glue ink, the polymeric coating remains substantially on Medium B after separation, even under pressure and/or heat conditions that are otherwise sufficient for transfer onto glue-ink-covered regions. This demonstrates that transfer is governed by the glue-ink-mediated interfacial interaction rather than by liner peel force or generic delamination of a film.

In further embodiments, lamination pressure and/or lamination heat may be applied selectively or non-uniformly using patterned rollers, segmented nip rollers, belts, platens, or zone-controlled heated rolls, such that polymer pickup is enhanced in high-coverage image regions while reducing background contact. In yet further embodiments, lamination may be performed in multiple passes, including a first pass for tack engagement and a second pass for consolidation, without departing from the disclosed system.

Following lamination, Medium B 120 is separated from Medium A 110 and discarded. FIG. 9. Medium A 110 medium remains bearing CMYK ink 112, white ink 114, glue ink 116, along with the transferred polymeric material 124 that is localized to imaged regions. The transferred polymeric material is relatively dry or non-flowable at ambient conditions compared to wet powder-coated DTF outputs.

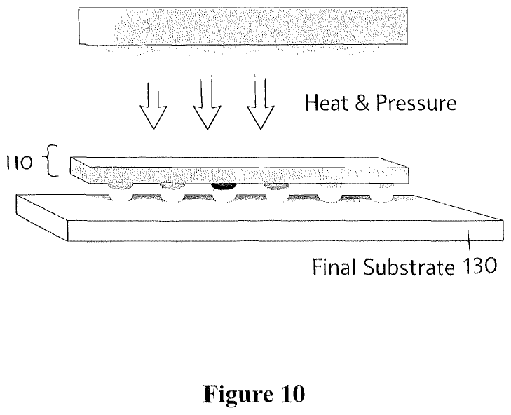

The composite image on the first transfer medium 110 after lamination with now discarded Medium B is transferred to a final substrate 130 using heat and pressure. FIG. 10. Suitable equipment includes manual or pneumatic heat presses. Typical transfer conditions may include pressures of approximately 20 to 40 psi and temperatures of approximately 300° F. to 400° F., although other conditions may be employed depending on substrate type, polymer composition, and desired durability.

During the final transfer step, the glue ink 116 and/or transferred polymeric material 124 may soften, flow, and optionally react (e.g., via latent or blocked crosslinkers) to anchor the image to the substrate surface and/or into fibrous structures. In textile embodiments, such anchoring can be configured to achieve high durability while maintaining reduced hand-feel relative to thick film transfers.

Lamination equipment may be integrated inline with the digital printer or provided as peripheral equipment. Inline laminating rollers, with or without heating capability, may be used to enhance production efficiency and to support continuous web or sheet workflows. The disclosed system is particularly well suited for compact digital printing platforms because it eliminates powder handling, powder recovery, tumbling chambers, and dust-control infrastructure, while enabling high-resolution, white-capable transfer printing with controlled polymer loading.

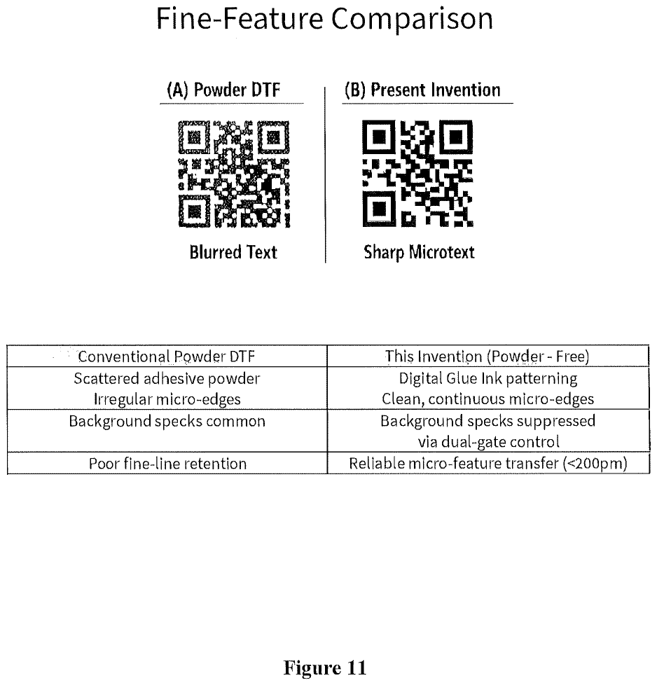

In certain embodiments, the disclosed system is particularly well suited for producing very fine image features, including microtext, fine halftone dots, line features, and machine-readable elements such as QR codes or data matrices. FIG. 11. Because polymer transfer from Medium B 120 occurs selectively through glue-ink-mediated interfacial interaction rather than through bulk powder deposition or continuous film lamination, the effective resolution of transferred polymer closely follows the resolution of the digitally printed glue ink layer. As a result, polymer deposition is confined to the precise boundaries of the digitally printed image, enabling transfer of fine features that would otherwise be degraded or obscured by powder agglomeration, mechanical tumbling, or film edge flow in conventional transfer processes. This selective, image-driven polymer pickup further contributes to improved edge definition, reduced background contamination, and enhanced scan ability of micro-features following final transfer.

In all such embodiments, the second transfer medium (Medium B) 120 functions as a sacrificial donor medium for the polymeric material and is not incorporated into the final transferred construction. Following lamination and separation, Medium B is discarded, while the first transfer medium retains the Color 112 image, white ink 114, glue ink 116, and selectively transferred polymeric material 124 localized to imaged regions. Accordingly, the carrier substrate of Medium B does not become part of the final image stack and does not remain bonded to the final substrate. This sacrificial configuration distinguishes the disclosed system from film-based transfer constructions in which a continuous carrier or adhesive film remains as part of the transferred layer, and further enables reduced hand-feel, improved flexibility, and fine-feature fidelity in the final transferred image.

In a further embodiment, the first transfer medium (Medium A) 110 is printed with one or more color inks to form the color image layer and with a glue ink layer, without depositing a white ink layer on Medium A 110. In this embodiment, the second transfer medium (Medium B) 120 comprises a non-substantial film-forming polymeric material that includes a white pigment, for example titanium dioxide (TiO₂). Upon lamination mediated by the glue ink layer and subsequent separation, the white-pigmented polymeric material is transferred only to image-corresponding regions of Medium A 110 and thereafter transferred to the final substrate 130. The selectively transferred white-pigmented polymeric material functions to provide optical hiding of the final substrate and to enhance color vibrancy and image quality of the overlying color image, while avoiding formation of a continuous background film. In this manner, effective substrate masking and color quality are achieved through the second transfer medium rather than through printed white ink on the first transfer medium, while preserving ink-defined weeding, sharp image boundaries, and soft hand-feel characteristics.

The disclosed powder-free system provides multiple advantages, including:
Elimination of fine polymer powders and associated safety hazards;
Improved consistency and uniformity of polymer deposition;
Enhanced capability to produce fine lines, small text, and detailed images;
Reduced equipment complexity and footprint;
Improved control over hand-feel and image thickness; and
Compatibility with dark substrates through white ink layering.

The disclosed embodiments may be adapted for non-textile substrates, including wood, leather, and polymeric surfaces. Variations in glue ink chemistry, polymer donor composition, lamination sequence, and heat-transfer conditions may be employed without departing from the scope of this supplemental disclosure.

### Self Weeding Imaging System

Another embodiment of the invention provides a digital transfer imaging system comprising ink jet inks having colorant, an enhancer ink that is white and/or colorless, and transfer media that limits transfer of system materials from transfer media to substantially only the imaged portion of transfer media. This embodiment typically does not involve three tiers. The ink jetted materials in combination with the transfer media provide an image on the final substrate having vivid colors, a soft hand, and a durable image. The ink jet printer sequentially applies process color inks, and enhancer materials, and/or white inks, and provides high-fidelity, durable images, transferring substantially only the imaged areas onto the final substrates, which may be textiles, ceramics, and polymers.

The ink jet inks comprise colorants that permit full color process printing. The inks are cyan, magenta and yellow (C.M, Y) or C, M, Y, K (black). The ink jet inks may comprise both pigments and sublimation dyes. The colorants in one embodiment are present in a ratio (by weight) of 15-30% pigments and 70-85% sublimation dyes. This combination used as described herein with the enhancer ink and transfer media provide a transfer system that may be used with the vast majority of substrates having porous surfaces, and is not limited to substrates comprising polymers as is the case with inks comprising only sublimation dyes as colorants.

An ink receptive layer of the transfer media comprising hydrophilic enabled tackifier medium is wetted by the liquid ink jet inks or the liquid ink jet inks and an enhancer. The enhancer, which may be an aqueous-based colorless and/or white ink, improves separation of the image from the transfer media and improves adhesion of the image to the final substrate. The enhancer is selectively applied to certain imaged portions of a transfer medium as required to achieve adhesion to a final substrate. The selective transfer of substantially only the image from transfer media is defined as weeding the image, or digital peeling or trimming the image, applying substantially only the imaged portion of the transfer media to the final substrate, and leaving the remainder of the transfer media on the base sheet of the transfer media.

In one embodiment, a software-controlled ink management system refines the process, by applying enhancer in quantities as needed to reinforce areas having insufficient adhesion to the final substrate due to insufficient liquid ink jet ink application that is a function of the image definition. During heat transfer, the imaged portions of the transfer media, swollen and raised due to the application of ink jet ink, or ink jet ink and enhancer, are adhered to the final substrate, resulting in clean digital weeding and improved image permanency on the receiving substrate. By optimizing ink adhesion, image clarity, and color depth, this invention enhances workflow efficiency and production scalability, making it a cost-effective solution for high-quality digital printing applications.

The present invention integrates transfer media, inkjet printing, and optionally, electrophotographic printing, employing a sequential imaging process to achieve high-quality, weeded image transfers. In one embodiment, a color image is first printed with dithering on the transfer media. An aqueous and/or white ink or toner layer is then printed onto a transfer medium comprising a hydrophilic tackifier. This structured layering enhances image clarity, adhesion selectivity, and transfer efficiency. During the final heat transfer step, the digitally produced color image is weeded from and released from the transfer medium (either paper or film) and permanently bonded to the receiving final substrate, ensuring substantially only the imaged areas are transferred, with the color image layer formed on the surface of the final substrate.

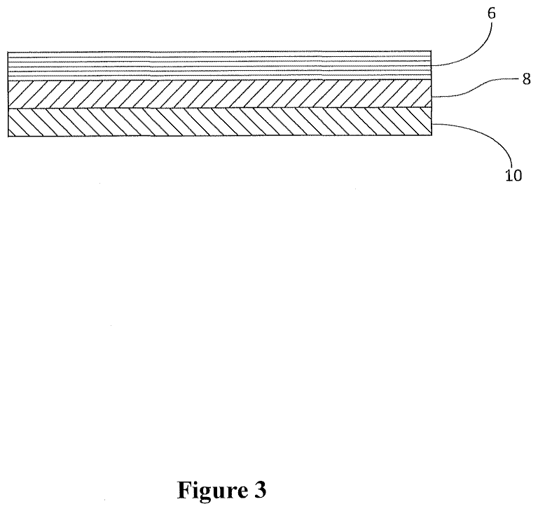

The transfer media may have a base layer of sufficiently strong paper or polymeric film that is heat tolerant during thermal transfer. FIG. 3. The base layer 10 may have a release layer 8 coated thereon to enhance release, and an ink receptive layer 6 having a coating that enhances liquid inkjet ink deposition quality and precision. The coated layers comprise chemicals that remain colorless and are transparent when heated during the heat transfer step of the process. Optionally, chemicals or polymeric materials with hydrophilic properties may be present in the ink receptive layer to enhance the liquid ink receptivity and image dot definition. A silicon release coating may be used for the release layer to increase transfer efficiency.

The ink-receptive layer comprises at least one hydrophilic tackifier that absorbs solvents, such as water, alcohol, glycol, and water-miscible solvents. Upon absorption, the tackifier swells, becoming tacky and slightly raised from the transfer medium, facilitating enhanced contact and adhesion with the final receiver substrate. The release layer of the transfer medium further facilitates transfer.

The hydrophilic tackifier is preferred to be a polymeric material that becomes tacky or sticky when wetted, such as by water in the ink jet ink or the enhancer ink. The hydrophilic tackifier is further softened by heat during image transfer from the transfer medium to the final substrate, which aids bonding of the image layer to a porous surface of a final substrate. It is preferred that softening point for the hydrophilic tackifier to enhance bonding of the image layer is above 150° C., and more preferably is above 170° C.

The ink receptive layer of the transfer media is applied over the release layer using aqueous-based, solvent-based, hot melt, extrusion, transfer, or lamination coating methods. The dry coat weight may range from 5 to 60 g/m², and is preferably 10 to 30 g/m². The release layer provides a controlled image release mechanism, ensuring clean separation during transfer for the present digital weeding imaging method. The base sheet may be a paper or film that can withstand the image transfer temperature without material change in color, structure or composition.

An optional clear polymer layer may be used to form the transfer media. This layer has high affinity for thermally diffusible colorants, such as solvent dyes, pigments, disperse and sublimation dyes. Polyester, polyamide, acrylic/acrylate, and nylon are preferred materials due to their flexibility and bonding properties.

Dry Component Example of Ink-Receptive Layer

| Component | Weight % |
|---|---|
| Hydrophilic Tackifier Agent | 10-65% |
| Binders | 5-50% |
| Coating Additives & Fillers | 5-35% |

Preferred liquid inkjet inks used for the present invention are aqueous in nature with the primary ingredients being hygroscopic solvents to include water. Colorants that are pigments and sublimation dyes are preferred to be used in the inkjet ink, with the sublimation dyes or pigments being of a single color or a combination of colors. Disperse dyes, solvent dyes, sublimation dyes, organic pigment, inorganic pigments, leuco colorant, fluorescent colorants, radiation-chromatic and/or thermochromic colorants, optical brighteners (which show color under ultraviolet radiation), IR colorant, etc. are among the suitable colorants for the invention.

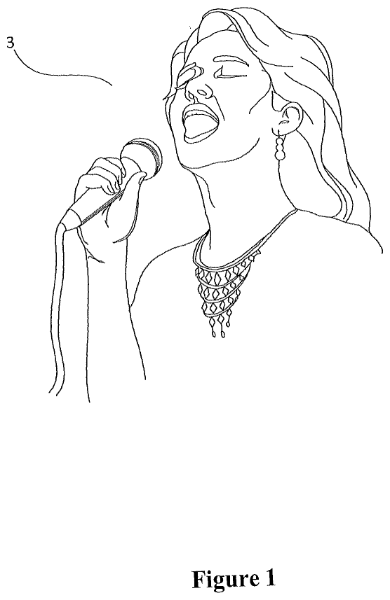

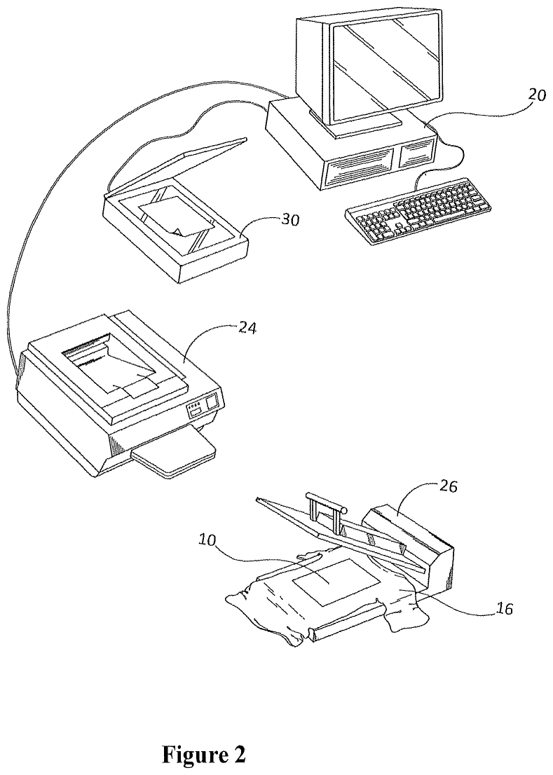

FIGS. 1 and 2 demonstrate a typical transfer process. FIG. 1 shows a digital image 3 that is stored on a computing device. The image may be created on the computing device 20 copied from another computing device, scanned 30, or otherwise created. The image is printed on transfer media 10 by a printer 24, which in this embodiment is an ink jet printer. The image is transferred to a final substrate by heat and pressure, which may be applied by a heat press 26. As shown, the final substrate is a textile, and more particularly, a shirt 16.

The inks may be aqueous liquid inks, such as ink jet inks described in U.S. Pat. Nos. 5,488,907 and 8,632,175. Preferably, at least one ink set with three colors of inks of Cyan (C), Magenta (M), and Yellow (Y) are used to create process color images. An ink set with Cyan, Magenta, Yellow and Black (K) inks is preferred if suitable print channels of the ink jet printer are available. The hydrophilic components in preferred inks may include water, alcohols, glycols, various diols, polyol, thios, amine or polyamine, and water soluble cosolvents.

Minute ink droplets are discharged and displaced on the surface of the transfer medium. Full color images may comprise hundreds to billions of small ink droplets. In lighter colored portions of the image relatively small amounts of color ink may be deposited. When the quantity of image forming ink is sufficient to produce a quality image, but the color ink supplies insufficient water or other liquid to cause the imaged portion of the transfer medium to become sufficiently tacky or sticky to facilitate transfer to the final substrate, an ‘enhancer’ ink is used to increase the water and/or other liquid applied to the imaged portion of the transfer medium to achieve the level of stickiness or tackiness required to weed or separate the entire image from the transfer medium.

The enhancer will typically comprise water and may also comprise alcohols, glycols, and other components. The enhancer ink is preferred to be colorless in one embodiment so that it does not distort or modify the colors of the image produced by the ink jet inks that comprise colorants. The enhancer preferably contains no thermally diffusible colorants, or if contained, the level of colorants is sufficiently low such that the colorant is not visible with the naked eye after application of the colorless enhancer ink to the image.

The printer that applies the enhancer is typically the same printer that prints the color image. It is therefore advantageous and preferred that the enhancer ink has the same or similar physical properties as the color ink, such as viscosity, viscoelasticity, specific gravity, surface tension, pH value/alkalinity, and evaporation speed as the image forming aqueous inkjet ink.

As is further disclosed herein, the system allows the production of an image on a wide variety of final substrates. The system is not limited to polymer comprising substrates as is the case with sublimation inks. The system may be used to image cotton and other textiles that can tolerate the transfer temperatures with image quality that is comparable to or better than imaging with sublimation inks and without coating or preparing the surface of the cotton substrate with a polymer. At the same time, the system provides weeding of the image so that coatings of the transfer media that are not imaged are not transferred to the final substrate. The addition of reactive components within the enhancer ink produces a more permanent image on certain substrates such as natural fabrics and wood that have hydroxyl groups.

In one embodiment, an isocyanate is added to enhancer ink. The isocyanate reacts with the hydroxyl groups in textiles such as cotton that have hydroxyl groups during transfer of the image under heat and pressure. Other textile materials, wood and other materials that are useful as substrates, comprise hydroxyl groups that crosslink and bond with the final substrate as a result of the isocyanate in the enhancer. In an embodiment, a blocked isocyanate remains inactive during storage, but is unblocked at the heat transfer temperature. Crosslinking is activated by heat to provide reaction and bonding only during the transfer process. The image is strongly bonded to the final substrate, and due to weeding facilitated by the transfer media, no unwanted materials from the transfer media are applied to the final substrate.

Suitable crosslinking chemistries for inkjet applications include:
Polycarbodiimide Crosslinkers—React with carboxyl-containing polymers to enhance water resistance and mechanical durability.
Epoxy-Based Crosslinkers—Provide strong covalent bonding with hydroxyl or amine-functionalized binders, ensuring chemical resistance.
Melamine-Formaldehyde Crosslinkers—Offer high durability and adhesion when used with polyester or polyurethane-based binders.
Aziridine Crosslinkers—Effective in improving adhesion and flexibility, particularly for polymeric substrates.
Zirconium-Based Crosslinkers Improve bonding strength, particularly for cellulose-based and metal substrates.
Silane-Based Crosslinkers-Promote adhesion to inorganic surfaces such as glass, ceramics, and metals.
Blocked Isocyanate Crosslinkers-Remain stable in ink formulations and activate at elevated temperatures to form highly durable polymer networks.

By incorporating crosslinking components into the enhancer ink, the invention ensures enhanced ink-substrate interaction in addition to generating tackified image, making the transferred image more resistant to environmental stress, chemical, and/or physical wear.

The present invention can use either sublimation or non-sublimation colorants in color inks but is preferred to comprise both pigments and sublimation dyes. The inventors have demonstrated that when pigments and sublimation dyes are used in combination and transferred with the polymeric material that forms the hydrophilic layer of the transfer media, wash fastness for images applied to natural fabrics is substantially and unexpectedly improved. It is believed that a 100% cotton substrate is imaged with the systems of the invention and washed with a consumer washing machine is materially improved over the use of commercially available inkjet inks comprising only sublimation dyes.

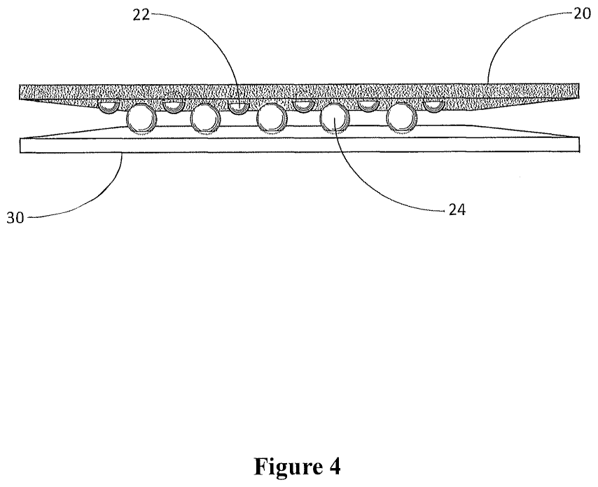

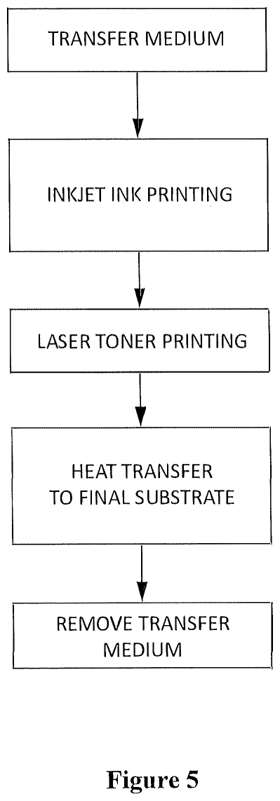

The polymeric material forming the ink receptive layer provides the polymer for which the sublimation dyes have an affinity, initiated by heat transfer. Without being bound by theory, it is believed that the polymeric material 20 of the ink receptive layer 6 transferred from the receiver medium holds the pigments into the textile 30 or other final substrate, and particularly a final substrate with porosity at the surface. The sublimation dyes 22 move toward the polymeric material for which they have an affinity, leaving the pigments closer to the final substrate. See FIG. 4, which is not to scale, since the ink receptive layer and textile are closer together after transfer, but demonstrates relative movement of the sublimation dyes and pigments when the sublimed sublimation or disperse dyes have little to no affinity for the final substrate.

The system comprising ink jet ink, enhancer and transfer media with hydrophilic polymeric material that becomes tacky when wet provides an imaging system that is useful with a wide variety of substrates that have porous surface characteristics and/or comprise a polymer for which sublimation inks have and affinity and/or have hydroxyl groups. While the system provides imaging that will adhere and/or bond to a wide variety of substrates, the enhancer and transfer media work together to substantially transfer only the imaged portion of the final substrate.

For example, if the final substrate comprises a polymer, such as a polyester textile, the sublimation dyes in the ink will bond to the substrate. If the final substrate comprises hydroxyl groups, crosslinker in the enhancer ink will provide crosslinking and binding of the image, with image quality and wash fastness enhanced by the polymeric receiver material of the transfer media that binds the pigment to the substrate while also providing a polymer for which the sublimation dyes have an affinity. Ceramic materials have a porosity that results in mechanical bonding of the image to the ceramic.

White pigments, particularly titanium dioxide (TiO₂), may be incorporated into the ink formulation to serve multiple functions within the imaging process. White pigmented inks can be used in conjunction with the enhancer, or as the enhancer, depending upon the application. TiO₂-pigmented inks may be used to create a white or light color background for the transferred image, ensuring high opacity and contrast when imaging black or other dark final substrates. By overprinting a white ink layer, on the image or alongside the image, and whether alone or in combination with colorless enhancer ink, the transferred image as it appears on the final substrate exhibits greater vibrancy, clarity, contrast, and color accuracy, while also preventing the background color of the final substrate from adversely affecting the printed image.

Additionally, ink comprising white pigment may be used to add white-colored portions within the final image, rather than merely serving as a background. This is particularly beneficial for high-contrast designs, logos, or artistic elements where white is an essential part of the visual composition. By layering white ink selectively, the printing process can achieve improved dynamic, high-resolution, and commercially appealing results.

The white ink may be applied using a sequential or simultaneous printing method with enhancer and colored inks, ensuring smooth integration and optimal image adhesion on the final substrate. Depending on the substrate and hardware availability, an ink jet printer having multiple ink channels and/or printing passes of white inkjet deposition increases opacity and consistency, while maintaining precise dot control and registration for both digital weeding and color reproduction purposes.

Enhancer ink and/or white pigmented ink may be formulated using liquid or carrier-miscible ingredients with at least one hygroscopic solvent, such as glycols or polyhydric alcohols, to create a jettable liquid formulation. The addition of hygroscopic components enhances ink stability, adhesion, sustainability of tackiness and penetration, and are particularly useful for substrates with varying porosity and surface energy. This ensures a well-balanced ink system that provides durability, smooth layer formation, and excellent transfer efficiency. Reactive component(s) and/or crosslinking agents and catalysts may also be used in one, multiple or all of the inks.

For optimal printhead compatibility and ink performance, the formulation of white pigmented inks may include dispersing agents, rheology modifiers, and stabilizers to prevent pigment aggregation and sedimentation. Viscosity control is important, as high pigment loading can impact jetting behavior, requiring advanced dispersion techniques to maintain smooth ink ejection and reliable printhead performance.

One embodiment for the present invention uses a multiple-printhead, multiple-channel inkjet printer, where each channel is controlled independently to form full-color images with specialized inkjet specifications. For example, cyan, magenta, yellow, and black (C, M, Y, K) aqueous liquid inks are provided to each channel and deposited to create a composite color image on the transfer medium. Following the initial color deposition, white and/or colorless enhancer ink may be jetted either from at least one of the channels within a single printhead or from an additional printhead on the same printer.

This flexibility allows the system to apply white ink and/or a clear colorless ink over or between color layers, optimizing adhesion and visual contrast on dark or colored substrates. The white ink provides an opaque base to enhance color brightness and fidelity, while the enhancer serves to improve image adhesion to the final substrate. The combination of these specialized inks allows for:
Underprinting (White Base Layer+CMYK Layers)—White ink applied first to ensure color accuracy and opacity on dark substrates, suitable for transparent or translucent receiving substrate applications.
Overprinting (CMYK Layers+White Ink or Clear Ink Enhancer)—Selective addition of white highlights or gloss layers for design elements, suitable for dark and black color receiving substrates.
Interleaving (Colorless Adhesion Layer+White Ink+Color Layers)—Using a colorless ink layer before white ink to improve adhesion and after white ink to enhance bonding with color layers, especially used for transparent and/or translucent receiving substrates.

By enabling the integration of colorless and white ink through either a dedicated ink channel in one printhead or an additional printhead, this invention significantly expands the printing versatility and application range, making it ideal for high-quality, durable digital transfer printing across various substrates.

A software driver capable of tracing the color image ensures that a sufficient amount of ink of all colors, plus the enhancer ink, is applied to cause sufficient tackiness or stickiness to hydrophilic tackifier to achieve weeding of the image from the transfer media. When a discretely produced dither or image portion is small or when the amount of ink jet ink is deposited in a specific portion of the imaged area is otherwise too low, the hydrophilic tackifier is insufficient to transfer the image from those areas to the final substrate. Additional liquid must be applied without interfering with image quality. Detection is provided by the imaging process of the invention to determine which part of the image receives inadequate liquid during the ink jet printing process to achieve the required tackiness. In a preferred embodiment an algorithm detects where the liquid application is inadequate and applies enhancer ink to the image to provide sufficient liquid to provide complete adhesion between the tackified portion that comprises the image and the final receiver substrate, ensuring cohesive forces among materials during transfer to cause the imaged portion to separate cleanly and completely from the remainder of the transfer medium and transfer to the final substrate.

In cases where an image contains large continuous portions alongside slimmer or smaller details, the transfer process may be inconsistent. It has been observed that part of an image is smaller than approximately three times the coating layer thickness, it may fail to transfer adequately due to inadequate hydration of the receiver media. In this case, additional enhancer is applied to hydrate the transfer media's ink receptive layer to cause swelling and sufficient tackiness for transfer. Preferably, the enhancer ink is jetted by the printer from through a dedicated channel in the inkjet printer, with dedicated channel system controlled by a digital imaging driver or raster image processor (RIP). In one embodiment, the calculation of precise location and quantity of hydration compensation by the enhancer ink occurs at the image rendering stage before printing.

Ideally, each pixel of the image is monitored to measure the total amount of ink jet ink applied to each pixel of the image to determine if the entire image is sufficiently wetted. If the deposited aqueous liquid inkjet ink during image formation provides insufficient liquid to penetrate and sufficiently enable the hydrophilic tackifier agent in the ink receptive layer, additional enhancer ink is applied to the area of the image that received insufficient liquid. Summarily, while enhancer may be applied to the entire image prior to transfer, it is preferred that additional enhancer is applied to the area/pixels where hydration is deemed to be insufficient and according to the amount of additional enhancer needed at the area/pixels.

The color of the image is a factor in determining area(s) of the image that require supplementing liquid supplied by the enhancer. Since full color may be created by combining C, M, Y inks, darker colors are more likely to receive more ink jet ink and therefore more liquid. Lighter portions of an image may receive insufficient liquid ink, which may result in a portion of the receiver medium, while imaged, being inadequately tacky to weed from the receiver medium and transfer to the final substrate. For example, a faint yellow image comprising only 5% ink coverage may result in an ink thickness of less than 1 micron and an attendant low quantity of liquid, resulting in a portion of the image that does not weed and transfer. The system detects these areas of inadequate hydration and directs the printer to apply additional enhancer to meet the required hydrophilic tackifier saturation threshold for transfer.

A software-controlled print driver may be used to manage the ink application process in multi-channel inkjet printing systems. The driver receives graphic design data, processes color matching, performs color separation, and generates a halftone map for ink deposition. The system converts RGB image data into corresponding C, M, Y values, applies gamma corrections, and then integrates the enhancer ink by evaluating ink saturation levels. By dynamically adjusting the amount of colorless enhancer ink in real time, the system ensures complete and accurate image transfer to the final substrate.

To optimize hydration of the imaged areas of the receiver media, an algorithm may be employed to evaluates each pixel of the image to determines the quantity of enhancer ink for proper transfer of the image from the receiver media. The algorithm ensures adequate hydration of every pixel and prevents incomplete transfer of portions of the image. The aqueous ink jet ink interacts with the hydrophilic tackifier of the transfer medium to create tackiness and adhesion, enabling a strong bond of the weeded image to the final receiver substrate. The adhesion is influenced by wetting properties and resistance to detachment from the transfer medium. The receiver substrate is often porous, such as textile or fabric surfaces, enhancing ink penetration into the substrate and providing image durability.

An example algorithm appears below. Variables width and height, and the minimum and maximum ink deposit of each imaged area/pixel are determined and applied.

```
  CMYE_Bitmap generateEnhancer(CMY_Bitmap
  cmyBitmap, float minimumCoating, float
  maximumCoating,intsurround-
  ingPixelRadius)
  {
CMYE_Bitmap cmyeBitmap;
for(int x=0; x < cmyBitmap.width; x++ )
      {
            for(int y=0; y < cmyBitmap.height; y++ )
            {
              Point currentPosition(x, y);
              CMY_Pixel cmyPixel =
              cmyBitmap.pixel(currentPosition);
            CMYE_Pixel cmyePixel;
            cmyePixel.c = cmyPixel.c;
            cmyePixel.m = cmyPixel.m;
            cmyePixel.y = cmyPixel.y;
      float totalInk = getSurroundingPixelTotalInk(cmyBitmap,
currentPosition, surroundingPixelRadius);
          float area = 3.14 * power(surroundingPixelRadius, 2);
          cmyePixel.e = 1 − totalInk / area;
          cmyePixel.e = maximum (minimumCoating, cmyePixel.e);
          cmyePixel.e = minimum (maximumCoating, cmyePixel.e);
          cmyeBitmap.pixel(currentPosition) = cmyePixel;
        }
    }
    return cmyeBitmap;
}
```

The imaged area of the ink receptive layer of the transfer medium is selectively separated from the non-imaged area of the transfer medium during heat transfer of the image to the final substrate by the adhesion of the image facilitated by hydration of the image receptive layer of the transfer media. Undesirable ‘hand and feel’ effects from components of the transfer media that are non-imaged are avoided. The process prevents residue accumulation, and minimizes long-term discoloration of non-imaged portion of transfer media that are commonly used for sublimation transfer.

The image is transferred from the transfer medium to the final substrate by the application of heat and pressure. Intimate contact under pressure is provided between the imaged portion of the transfer medium and the final receiver substrate. Heat facilitates diffusion of thermally activated colorants, such as sublimation dyes, through the transfer coating layers, and further promotes tackiness of the polymeric material of the ink receptive layer. Some applications may require temperatures around 200° C., and extended press durations ranging from several seconds to a few minutes. A chamber heat press with vacuum capability sometimes enhances transfer efficiency.

An alternative exemplary algorithm is presented for use when white ink is used for overlaying color images and is used to weed the image. Every are/pixel of the CMYK-printed image is covered with white ink.

### Algorithm: GenerateWhiteInkOverlay

This algorithm takes in a CMYK bitmap image and generates a white ink overlay with precise coverage.

### Inputs:

CMYK_Bitmap cmykBitmap: The original CMYK-printed image.
float minWhiteInk: The minimum deposit level of white ink.
float maxWhiteInk: The maximum deposit level of white ink.
int min FeatureSize: The smallest feature to be covered (75 microns).
int contourExpansion Radius: The expansion radius for the contour in pixels.

### Outputs:

White_Bitmap whiteBitmap: A bitmap representing the white ink overlay.

```
      White_Bitmap generateWhiteOverlay(CMYK_Bitmap cmykBitmap,
                    float minWhiteInk,
                    float maxWhiteInk,
                    int minFeatureSize,
                    int contourExpansionRadius)
      {
        White_Bitmap whiteBitmap;
        int width = cmykBitmap.width;
        int height = cmykBitmap.height;
        // Step 1: Identify Inked Regions (CMYK Presence)
        for (int x = 0; x < width; x++) {
          for (int y = 0; y < height; y++) {
            Point currentPosition(x, y);
            CMYK_Pixel cmykPixel = cmykBitmap.pixel(currentPosition)
            float totalInk = cmykPixel.c + cmykPixel.m + cmykPixel.y + cmykPixel.k;
        // Step 2: Determine White Ink Coverage
            White_Pixel whitePixel;
            if (totalInk > 0) { // Only apply white where CMYK exists
              float coverage = minWhiteInk + ((maxWhiteInk − minWhiteInk) * (totalInk /
      4.0)); // Normalize to range
            whitePixel.w = max(minWhiteInk, min(maxWhiteInk, coverage));
          } else {
                  whitePixel.w = 0; // No white ink on blank areas
      }
      whiteBitmap.pixel(currentPosition) = whitePixel;
    }
  }
  // Step 3: Expand White Ink Coverage Using Contour Technique
  for (int x = 0; x < width; x++) {
    for (int y = 0; y < height; y++) {
      if (whiteBitmap.pixel(Point(x, y)).w > 0) {
        // Expand white coverage around the existing inked area
        for (int dx = −contourExpansionRadius; dx <= contourExpansionRadius; dx++) {
            for (int dy = −contourExpansionRadius; dy <= contourExpansionRadius; dy++) {
              int nx = x + dx;
              int ny = y + dy;
              if (nx >= 0 && nx < width && ny >= 0 && ny < height) {
                if (whiteBitmap.pixel(Point(nx, ny)).w == 0) {
                  whiteBitmap.pixel(Point(nx, ny)).w = minWhiteInk; // Extend minimum
white coverage
              }
            }
          }
        }
      }
    }
  }
  // Step 4: Ensure Minimum Feature Size (75 Micron Threshold)
              for (int x = 0; x < width; x++) {
for (int y = 0; y < height; y++) {
      int coveredPixels = 0;
      for (int dx = −minFeatureSize; dx <= minFeatureSize; dx++) {
        for (int dy = −minFeatureSize; dy <= minFeatureSize; dy++) {
          int nx = x + dx;
          int ny = y + dy;
          if (nx >= 0 && nx < width && ny >= 0 && ny < height) {
            if (whiteBitmap.pixel(Point(nx, ny)).w > 0) {
              coveredPixels++;
            }
          }
        }
      }
      if (coveredPixels < (minFeatureSize * minFeatureSize) / 2) {
        whiteBitmap.pixel(Point(x, y)).w = maxWhiteInk; // Reinforce coverage
      }
    }
  }
  return whiteBitmap;
}
```

### Algorithm Explanation:

1. Identify CMYK-Inked Regions:
   The algorithm scans the entire image and calculates the total ink coverage at each pixel.
   If a pixel has any CMYK ink, a proportional amount of white ink is applied.
2. Expand White Ink Coverage (Contour Technique):
   Ensures that white ink extends beyond each CMYK-inked region using a contour expansion radius.
   Prevents any gaps in coverage.
3. Maintain Minimum Feature Size (75 Microns):
   Ensures that no part of the image smaller than 75 microns is left uncovered.
   Small details are reinforced with additional white ink.

Additional white ink may be required for imaging white portions of the image that do not comprise CMYK inks, particularly when imaging dark or black substrates where white is needed as a standalone color rather than underlying the image layer to provide background for the image. In such cases, employment of further algorithms for color management and ink displacement should be considered in order to distinguish between white ink used as overlay (prior to transfer) and white ink used for image-forming. White ink intended for image formation may not be applied according the same criteria as where the white ink acts to undercoat the image on dark substrates. Additionally, intelligent layering techniques should be implemented to prevent excessive ink buildup while maintaining opacity, print sharpness, and adhesion to the substrate.

The below algorithm is an example of the process. This algorithm demonstrates that white ink is used effectively both as an undercoat/overlay for CMYK and as a standalone color where needed.

### Inputs:

CMYKW_Bitmap cmykwBitmap: The original image with CMYK and W layers.
float minWhiteInk: The minimum white ink deposit.
float maxWhiteInk: The maximum white ink deposit.
int contourExpansionRadius: Expansion radius for overlay white coverage.
int minFeatureSize: Minimum feature size (75 microns) to ensure full coverage.

### Outputs:

White_Bitmap whiteBitmap: A bitmap that distinguishes between overlay white and image white.

```
White_Bitmap generateWhiteLayer(CMYKW_Bitmap cmykwBitmap,
                float minWhiteInk,
                float maxWhiteInk,
                int contourExpansionRadius,
                int minFeatureSize)
{
  White_Bitmap whiteBitmap;
  int width = cmykwBitmap.width;
  int height = cmykwBitmap.height;
  // Step 1: Identify Regions Requiring White Ink
  for (int x = 0; x < width; x++) {
    for (int y = 0; y < height; y++) {
      Point currentPosition(x, y);
      CMYKW_Pixel cmykwPixel = cmykwBitmap.pixel(currentPosition);
      float totalInk = cmykwPixel.c + cmykwPixel.m + cmykwPixel.y + cmykwPixel.k;
      float whiteComponent = cmykwPixel.w;
      White_Pixel whitePixel;
      if (whiteComponent > 0) {
        // Step 1a: White as an Image Color (Direct Print)
        whitePixel.w = max(minWhiteInk, min(maxWhiteInk, whiteComponent));
      } else if (totalInk > 0) {
        // Step 1b: White as an Undercoat (Overlay for CMYK)
              float overlayCoverage = minWhiteInk + ((maxWhiteInk − minWhiteInk) *
      (totalInk / 4.0)); // Normalize coverage
whitePixel.w = max(minWhiteInk, min(maxWhiteInk, overlayCoverage));
      } else {
        // No white ink needed in blank areas
        whitePixel.w = 0;
      }
      whiteBitmap.pixel(currentPosition) = whitePixel;
    }
  }
  // Step 2: Expand White Overlay Using Contour Technique
  for (int x = 0; x < width; x++) {
    for (int y = 0; y < height; y++) {
      if (whiteBitmap.pixel(Point(x, y)).w > 0) {
        // Expand white underlay around the existing CMYK-inked area (if no standalone W is
present)
        for (int dx = −contourExpansionRadius; dx <= contourExpansionRadius; dx++) {
          for (int dy = −contourExpansionRadius; dy <= contourExpansionRadius; dy++) {
            int nx = x + dx;
            int ny = y + dy;
            if (nx >= 0 && nx < width && ny >= 0 && ny < height) {
              if (whiteBitmap.pixel(Point(nx, ny)).w == 0 && cmykwBitmap.pixel(Point(nx,
ny)).w == 0) {
                whiteBitmap.pixel(Point(nx, ny)).w = minWhiteInk; // Extend overlay
coverage
              }
            }
          }
        }
      }
    }
  }
  // Step 3: Ensure Minimum Feature Size (75 Microns)
  for (int x = 0; x < width; x++) {
    for (int y = 0; y < height; y++) {
      int coveredPixels = 0;
      for (int dx = −minFeatureSize; dx <= minFeatureSize; dx++) {
        for (int dy = −minFeatureSize; dy <= minFeatureSize; dy++) {
          int nx = x + dx;
          int ny = y + dy;
          if (nx >= 0 && nx < width && ny >= 0 && ny < height) {
            if (whiteBitmap.pixel(Point(nx, ny)).w > 0) {
              coveredPixels++;
            }
          }
        }
      }
      if (coveredPixels < (minFeatureSize * minFeatureSize) / 2) {
        whiteBitmap.pixel(Point(x, y)).w = maxWhiteInk; // Reinforce coverage
      }
    }
  }
  return whiteBitmap;
}
```

### Algorithm Enhancements for CMYKW:

1. Differentiates White Usage:
   Undercoat White (W_Overlay) is applied under all CMYK portions.
   Image White (W_Image) is directly printed for white-colored areas.
2. Ensures Full Coverage Without Excessive Ink Waste:
   Expands the white undercoat layer where needed.
   Does not apply an undercoat where white ink is already present as an image color.
3. Prevents Gaps or Weak Coverage:
   Enforces a minimum feature size (75 microns) to ensure no fine details are missing.
4. Avoids Overlapping White Ink Application:
   If an area already has standalone white (W), the undercoat is not applied.

The above algorithm example integrates CMYKW printing, distinguishing between white as an overlaying layer and white as an image component. It ensures proper coverage for all printed areas while optimizing ink usage.

Other inkjet ink ingredients that may be used include purified water, physical property adjustment agents, humectants, pH buffers, chelating agents, viscosity control agent, etc. may be used. The usage level of each chemical or material to achieve the best performance for each application is determined. Special chemicals or materials such as color enhancers, polymeric or long chain protein peptide materials for colorant affinity or receptiveness, may also be used.

An inkjet ink includes at least one viscosity modifier to reduce volatile organic content (VOC) and humectant additives such as glycols. This allows the ink to dry quickly while maintaining good inkjet jetting quality and ink dot formation. The viscosity modifiers are polymeric, either organic or inorganic, and may be used in low percentages (1% to 2% by weight) while maintaining Newtonian fluid characteristics.

Viscosity control agents play a crucial role in modern digital printing, offering benefits like reduced VOC emissions, increased drying speed, and maintenance of fluid characteristics, which are essential for high-quality and environmentally friendly printing processes. Organic thixotropes, based on castor oil derivatives, polyester-amides, and polyamides, function through hydrogen bonding, deagglomeration, and swelling of particles. They provide excellent thixotropic properties without cross-linking, making them suitable for solvent and UV ink applications due to their ability to form a continuous network and increase viscosity.

Acrylic thickeners, including Alkali-Swellable Emulsions (ASE) and Hydrophobically Modified Alkali-Swellable Emulsions (HASE), swell upon neutralization with alkaline additives, thereby increasing viscosity. These thickeners are particularly effective and preferably used in the current invention. Their long polymer chains allow for significant expansion when neutralized, resulting in increased viscosity and achieving specific rheological properties.

Hydrophobically Modified Polyurethane (HEUR) and Polyether Polyol (PEPO) thickeners interact with both hydrophobic and hydrophilic components in ink formulations. By forming a network that increases viscosity while maintaining Newtonian flow characteristics, these thickeners are ideal for the current invention. Their molecular weight and structure enable effective interaction with other components in the ink formulation, providing customizable rheology and enhancing the ink's performance for the imaging applications.

The molecular weight characteristics and long chain requirements of these thickeners can be significant. Thixotropic agents typically have high molecular weights, necessary to create networks that can trap solvents and produce the desired thixotropic effect. Similarly, acrylic thickeners have high molecular weights, impacting their ability to swell and form viscous solutions upon neutralization. HEUR and PEPO thickeners also rely on long polymer chains with both hydrophilic and hydrophobic segments, which interact with other molecules in the ink, creating a network that increases viscosity while maintaining Newtonian flow characteristics.

The mechanisms of action for these agents may involve hydrogen bonding and physical network formation. Organic thixotropes form networks through hydrogen bonding, trapping solvents and other molecules to provide the desired viscosity and thixotropic properties. Acrylic thickeners swell when neutralized, as the carboxylic groups along the polymer chains repel each other, causing the chains to swell and increase the solution's viscosity. HEUR and PEPO thickeners form networks through associative interactions between hydrophobic segments and the hydrophilic matrix, maintaining consistent viscosity and flow characteristics.

These thickeners and rheological additives are essential for formulating high-performance inkjet inks that balance viscosity, drying speed, and VOC content. By reducing VOC content and improving drying speed, these additives help create more environmentally friendly and efficient printing processes. The long-chain polymers and high molecular weight materials ensure that the inks perform well under various printing conditions, providing consistent and high-quality results, ensuring superior performance in modern digital printing technologies.

Examples of suitable viscosity modifiers include polymeric thickeners such as xanthan gum, polyacrylic acid, and cellulose derivatives like hydroxyethyl cellulose (HEC). These thickeners provide the necessary viscosity control without adversely affecting the ink's flow properties. Inorganic modifiers such as silica nanoparticles can also be used to achieve the desired rheological properties.

In addition to viscosity control, these modifiers play a crucial role in reducing the overall VOC content of the ink formulation. By optimizing the ink's composition, the amount of volatile solvents can be minimized, resulting in a more environmentally friendly product. This is particularly important in industrial and commercial printing applications where regulatory compliance and sustainability are key considerations.

Furthermore, the choice of viscosity modifier impacts the drying speed and final print quality. Rapid drying is essential to prevent smudging and ensure crisp, well-defined images. The modifiers should facilitate quick solvent evaporation while maintaining the integrity of the inkjet dot. This can be achieved through careful selection and balance of the ink components, including the solvents, colorants, and additives.

Suitable examples for viscosity modification include Lamberti's Thijet 170, known for its excellent thickening and flow properties. Similar products from other manufacturers include Kao Collins LUNAJET Ink, which offers low-VOC formulations, and BASF Joncryl LMV 7025, designed for high-performance inkjet printing. Scott Bader Acrylic Thickeners (ASE and HASE) and Fujifilm RxDR Dispersions are also effective in maintaining the desired rheological properties while enhancing print quality and acceptable drying speed.

In addition, to facilitate faster drying of inkjet inks and allow for sequential laser toner printing without significant delays, several other techniques can be employed. One effective approach is the use of fast-evaporating, water-soluble, and water-miscible drying solvents, which accelerate the evaporation process. Furthermore, integrating hot air-drying systems can rapidly remove moisture from the ink. Infrared (IR) and far-infrared (FIR) radiation are also highly effective, providing heat that speeds up solvent evaporation. Another method is the application of highly absorbent ink receptive coatings on the substrate, which allows for quicker ink absorption and reduces drying time. By combining these techniques, the drying speed of inkjet inks can be significantly enhanced, ensuring a seamless transition to subsequent laser toner printing.

The combination of using viscosity control agents, low VOC content, fast-drying ink chemistry, and effective ink/toner receptive coatings not only enables fast inkjet ink drying but also prevents the transfer medium coating with inkjet ink produced images from transferring/sticking to the laser printer fuser roller or other mechanisms. These thickeners and rheological additives are essential for formulating high-performance inkjet inks that balance viscosity, drying speed, and VOC content. By reducing VOC content and improving drying speed, these additives help create more environmentally friendly and efficient printing processes.

To further enhance the inkjet ink formulation, humectants such as glycerol, propylene glycol, and sorbitol can be added in controlled amounts at levels without substantial impede ink drying speed on transfer medium. These humectants help to maintain moisture content within the ink, preventing clogging of the printhead nozzles and ensuring consistent ink flow. However, excessive use of humectants can increase VOC levels, so their use must be carefully balanced with the viscosity modifiers.

Surfactants such as nonionic, anionic, or cationic surfactants can be incorporated to improve the wetting properties of the ink. These surfactants help the ink to spread evenly on the substrate, enhancing the uniformity and sharpness of the printed image. Suitable surfactants include but not limited to alkyl phenol ethoxylates, alkyl sulfates, and quaternary ammonium compounds.

Other reactive components suitable for inkjet ink applications may be used. Among various reactive chemicals, reactive surfactants are suitable for embodiments of the present invention if they meet three criteria: aqueous solubility, i.e. soluble or miscible with the liquid ink, stability in the ink and not reactive with ink carrier such as water, and reactive upon heat transfer during the image fixation step.

For instance, fluorine-based reactive fluorosurfactants may be used. These are a type of surfactant that contains fluorine atoms, which can provide unique properties of water solubility, reactivity or ability to chemically interact with other reactive ingredients, and provide stability in water dispersions. Fluorosurfactants are stable in water dispersions, which is important for inkjet applications where the ink should be stable and consistent.

Some examples of fluorosurfactants that may be used in the liquid inkjet ink include: fluorinated alkyl sulfonates (FAS), fluorinated alkyl carboxylates (FAC), fluorinated alkyl phosphates (FAP), and fluorinated alkyl sulfates (FAS).

Non-fluorine based reactive surfactants that meet the above requirements may also be used according to an embodiment, either alone or in combination of other ingredients. The following list exemplifies the component:
1. Alkyl sulfates (AS): These are a type of anionic surfactant that can be reactive and suitable for the invention such as sodium lauryl sulfate (SLS) and sodium laureth sulfate (SLES).
2. Alkyl ether sulfates (AES): These are similar to alkyl sulfates but have an additional ethylene oxide chain, which can enhance their reactivity and solubility.
3. Alkyl carboxylates (AC): These are a type of non-ionic surfactant that can be reactive and suitable for the present invention, such as sodium lauryl carboxylate and sodium laureth carboxylate.
4. Alkyl phosphates (AP): These are a type of anionic surfactant that can be reactive and suitable for the present invention, such as sodium lauryl phosphate and sodium laureth phosphate.
5. Alkyl sulfonates (AS): These are a type of anionic surfactant that can be reactive and suitable for the invention, such as sodium lauryl sulfonate and sodium laureth sulfonate.
6. Amine oxides (AO): These are a type of non-ionic surfactant that can be reactive and suitable for the invention, such as dimethylamine oxide and diethylamine oxide.
7. Quaternary ammonium compounds (Quats): These are a type of cationic surfactant that can be reactive and suitable for the invention, such as cetyltrimethylammonium bromide (CTAB) and cetylpyridinium chloride (CPC).

Example Ink Composition

| Component | Weight % |
|---|---|
| Colorant | 0-30% |
| Water-soluble Co-solvent/Humectants | 5-90% |
| Biocide | 0.05-1% |
| pH Control Agent | 0.1-0.5% |
| Surfactant | 0.1-15% |
| Reactive Component | 0-30% |
| Other Physical Property Adjustment Additives | 5-35% |
| Hygroscopic Solvent/Water | Balance |

At least one sublimation/heat activated colorant is used in a preferred for an embodiment of the invention. Sublimation colorants have a high affinity and color permanency for polymeric ester functional groups and produce vivid and permanent imagery results when heated to sublimation temperatures. Polyethylene terephthalate (PET), polybutylene terephthalate (PBT), polytrimethylene terephthalate (PTT), polyethylene naphthalate (PEN), polyester polyols, polyester amides, polyester sulfones, polyester carbonates, polyester urethanes, polyester isocyanate, polyester polyurethane, and the like have high sublimation colorant affinity for final image transfer to an object or surface.

The inkjet process of the present invention may use thermal inkjet (TIJ), bubblejet (BIJ), piezoelectric (PIJ) or continuous ink jet (CIJ). The objective is to deposit the liquid inkjet inks digitally without deteriorating the chemical and physical quality of the liquid, such as chemical stability and/or activities, color quality/authenticity, and composition ratio. Heating elements in the printer may be used to assist and maintain physical properties of the liquid ink before and during jetting or deposition by regulating the fluid dynamics, including, but not limited to, viscosity, surface tension and PH level. Ink liquid circulation provided for the ink reservoir/cartridge or at the printhead to ensure ink flow and prevent sedimentation, agglomeration, or precipitation.

Furthermore, other types of printers capable of delivering solid or pseudo-solid digitally include two-dimensional (2D) or three-dimensional (3D) solid ink or phase change inkjet printers, which utilize solid ink sticks made of a hot-melt resin-polymer that is melted at elevated temperature and jetted onto the substrate or transfer medium. This method is known for producing vibrant, long-lasting images and is often used in graphic design and advertising for striking visuals. Solid ink or phase change inkjet printers are particularly efficient for large-scale printing operations due to their ability to produce high-quality prints quickly and with minimal waste and can be adapted for the present invention. Additionally, Archipelago Technology's high viscosity inkjet printing system, Powerdrop™, and Tonejet's electrostatic drop-on-demand printing technology provide precise and efficient printing solutions capable of handling high-viscosity materials and direct-to-shape printing, enhancing the versatility of the hybrid imaging process.

These advanced printing technologies enhance the versatility and efficiency of the current hybrid imaging process, ensuring superior print quality and accommodating a wide range of industrial and commercial applications. By incorporating these technologies, the invention achieves a seamless integration of inkjet and laser printing methods, providing a robust solution for high-quality, durable, and efficient digital transfer printing.

These advanced printing technologies enhance the versatility and efficiency of the current hybrid imaging process, ensuring superior print quality and accommodating a wide range of industrial and commercial applications. By incorporating these technologies, seamless integration of inkjet and laser printing methods is achieved, providing a robust solution for high-quality, durable, and efficient digital transfer printing.

Reactive hot melt adhesive materials used for the present invention may be those that can be activated or reactivated at temperatures between 100° C. to 200° C. These materials may include: Epoxy-based adhesives, polyurethane-based adhesives, acrylic-based adhesives*, silicone-based adhesives, polyamide-based adhesives, polyimide-based adhesives, phenolic-based adhesives, phenolic-based adhesives, melamine-based adhesives, urea-based adhesive and most preferably polyester-based adhesives, due to the fact these adhesives are not only suitable for hot melt applications and can withstand temperatures up to 180° C., but also have high affinity for sublimation colorants.

The ink and/or toner receptive coating on top of the transfer paper may be further formulated to enhance the adhesion of both inkjet inks and electrophotographic toners. This coating is achieved using a carefully selected blend of polymers and additives that promote surface energy compatibility with inks and toners while improving adhesion and durability. Suitable polymers for this purpose include polyvinyl alcohol (PVA), polyethylene oxide (PEO), ethylene vinyl acetate (EVA), polyvinylidene amine (PVDA), polyvinylpyrrolidone (PVP), polyethyleneimine (PEI), and polyacrylic acid (PAA), all of which offer excellent hydrophilicity and ink-receptive properties. Polyvinyl butyral (PVB), polyurethane dispersions (PUDs), and acrylic copolymers, such as styrene-acrylic or acrylic-urethane copolymers, enhance film formation, mechanical flexibility, and adhesion to both liquid inks and dry toners.

In applications requiring controlled ink absorption, carboxymethyl cellulose (CMC) and polyether polyols (PEPOs) contribute to ink uptake and even distribution. Polyvinylidene fluoride (PVDF) and sulfonated polyesters provide improved chemical resistance and thermal stability, ensuring the integrity of the receptive layer under high-temperature transfer conditions. Additionally, silicone-modified polymers and maleic anhydride copolymers fine-tune surface energy, optimizing ink spread ability and adhesion without sacrificing release performance.

For applications demanding superior durability, polybenzimidazole (PBI) and blocked polyisocyanates enhance crosslinking capabilities, contributing to abrasion resistance and long-term print stability. These polymers, used individually or in combination, ensure strong adhesion, optimal ink and toner performance, and long-lasting image quality. Additives such as surfactants and dispersants further refine the coating's receptive properties, ensuring uniform ink and toner distribution while enhancing print sharpness and color vibrancy. By leveraging this tailored blend of materials, the receptive coating can be optimized to meet the demands of high-quality transfer printing across various substrates, including textiles, films, ceramics, and metals.

In addition to these core components, the transfer paper may also include anti-curl agents to ensure that the transfer medium remains flat during the printing and transfer processes, by applying to either the front or back side of the transfer medium. This is particularly important for maintaining precise alignment and registration of the printed images. Suitable anti-curl agents include plasticizers and other flexible polymers that balance the internal stresses within the transfer medium. These agents prevent curling and distortion, which can lead to misalignment and defects in the final transferred image.

Furthermore, the overall design of the transfer medium incorporates advanced materials and chemical formulations to meet the demanding requirements of modern digital printing technologies. The combination of high-quality base materials, precise application techniques for the release and receptive coatings, and the inclusion of specialized additives ensures that the transfer medium delivers consistent, high-quality results. By optimizing each layer's composition and properties, the transfer medium not only enhances the print quality but also improves the efficiency and reliability of the transfer process, making it an essential component for achieving vivid, durable, and high-fidelity images in various printing applications.

Producing such high-performance transfer medium may involve different coating methods that ensure optimal layer uniformity and functionality. One widely used technique is multiple-pass and/or multiple-station gravure coating, which involves engraving a pattern into a cylinder that transfers the coating material onto the paper or film. This method provides precise control over the coating thickness and uniformity, making it ideal for applying the release and receptive coatings. Another method is reverse roll coating, where the coating material is metered by a roller that rotates in the opposite direction of the substrate movement. This technique is known for its ability to apply thin, uniform coatings with excellent surface smoothness. Mayer rod coating, using a wire-wound rod to spread the coating material evenly, is another option that offers simplicity and versatility for various coating formulations. Additionally, slot-die coating and curtain coating are advanced methods that provide high precision and are suitable for large-scale production. Slot-die coating uses a precisely engineered die to deposit the coating material, while curtain coating involves creating a continuous curtain of liquid that falls onto the substrate, both ensuring uniform coverage and efficient material usage. By selecting the appropriate coating method based on the specific requirements of each layer, manufacturers can produce transfer media or transfer film with consistent quality and performance, tailored to the demands of modern digital printing applications. One skilled in the art can select and choose the most suitable method of paper/film coating according to specific application desires, ensuring the final transfer media meet all necessary performance criteria.

Dual Transfer Media Imaging Process with Digital-Weeding Capability

The digital transfer printing system utilizes a two-step transfer process, integrating a first transfer medium for inkjet printing and a second transfer medium for selective white pigment deposition. This ensures high-opacity, high-resolution image transfer with minimal background residue, addressing the need for vibrant prints on dark substrates without excessive layering or visible residue.

The first transfer medium is a critical component of the system, engineered to interact efficiently with inkjet inks. It comprises a hydrophilic polymeric coating that swells upon ink deposition, allowing for controlled tackiness. The hydrophilic layer consists of materials such as polyvinyl alcohol (PVOH), hydroxyethyl cellulose (HEC), polyacrylic acid (PAA), and other water-absorbing polymers. These materials ensure that the printed ink adheres precisely to the coated surface without excessive spreading or unwanted absorption.

The binder system within the first transfer medium plays a crucial role in defining the ink interaction. The selection of polymer molecular weight and crosslinking density affects adhesion strength, ink retention, and overall print clarity. Higher molecular weights can enhance adhesion but may reduce flexibility, while crosslinking density controls the degree of polymer network formation, impacting ink penetration and drying times.

The addition of humectants such as glycerol, ethylene glycol, and polyethylene glycol (PEG) further enhances moisture control, ensuring optimal ink drying times and preventing premature dehydration. These humectants help maintain a stable moisture environment, which is essential for consistent print quality.

To optimize image transfer efficiency, the first transfer medium includes surfactants and dispersing agents that regulate ink droplet spreading and penetration. The selection of surfactants, such as fluorosurfactants or alkyl sulfates, ensures uniform ink distribution while maintaining sufficient surface tack for subsequent pigment pickup.

Tackifier formulations may also include rosin esters or modified polyurethane resins, which further modulate the hydrophilic character of the surface layer. These tackifiers enhance the adhesion properties of the first transfer medium, ensuring effective interaction with the second transfer medium.

Inkjet printing onto the first transfer medium involves the deposition of aqueous-based CMYK color inks, white pigmented inks, and an optional colorless enhancer ink. The color inks contain pigment dispersions stabilized using polymeric dispersants to prevent agglomeration. Typical pigment particle sizes range between 50 nm and 300 nm to ensure proper inkjet nozzle compatibility and print resolution.

The second transfer medium incorporates a structured white pigment layer engineered for selective adhesion to the imaged regions of the first transfer medium. This medium consists of a multi-layered construction featuring a pressure-sensitive adhesive (PSA) base, a pigment-dispersed middle layer, and a hydrophilic tackifier top layer that interacts selectively with printed areas.

The PSA base is designed to remain inactive under normal handling conditions but activate under applied pressure. The formulation includes acrylic adhesives, such as copolymers of butyl acrylate and methyl methacrylate, modified with tackifiers to control adhesion properties. Hydrophobic PSAs, such as those based on acrylic or rubber, are preferred for their durability and water resistance.

The pigment-dispersed middle layer contains the white pigment, typically titanium dioxide (TiO₂), which is preferred for its high refractive index and opacity. Alternative white pigments include zinc oxide (ZnO) and barium sulfate (BaSO₄), each providing unique light-scattering properties. The pigment must be uniformly dispersed within a polymeric binder to prevent agglomeration and ensure consistent transfer behavior.

The hydrophilic tackifier top layer is a critical component that interacts selectively with printed areas, ensuring precise alignment of the white pigment layer with the imaged portions of the first transfer medium. Materials such as rosin esters or polyurethane-based tackifiers are effective in this role, providing controlled adhesion under pressure.

What is claimed is:

1. A system for imaging a substrate, comprising:
a digitally imaged substrate comprising an image layer, and a glue ink layer formed over the image layer;
a substrate comprising a non-substantial film forming polymeric coating formulated for lamination of the non-substantial film forming polymeric coating on the under pressure digitally imaged substrate.

2. The system for imaging a substrate of claim 1, wherein the digitally imaged substrate comprises a white ink layer positioned between the image layer, and the glue ink layer.

3. The system for imaging a substrate of claim 1, wherein the substrate comprising a non-substantial film forming polymeric coating further comprises a glue ink layer formed over the polymeric coating.

4. The system for imaging a substrate of claim 1, wherein the substrate comprising a non-substantial film forming polymeric coating further comprises a silicone release layer formed between the substrate and the non-substantial film forming polymeric coating.
